(19) United States
(12) Patent Application Publication
(10) Pub. No.: US 2023/0366105 A1
(43) Pub. Date: Nov. 16, 2023

(54) MICROELECTRODE AND METHOD FOR PRODUCING SAME

(71) Applicants: TECHNION RESEARCH AND DEVELOPMENT FOUNDATION LTD., Haifa (IL); H2PRO LTD, Caesarea (IL)

(72) Inventors: Gideon GRADER, Haifa (IL); Hen DOTAN, Richan (IL); Avner ROTHSCHILD, Haifa (IL); Avigail LANDMAN, Haifa (IL)

(21) Appl. No.: 18/246,599

(22) PCT Filed: Sep. 23, 2021
(86) PCT No.: PCT/IL2021/051155

§ 371 Date: Mar. 24, 2023

Related U.S. Application Data
(60) Provisional application No. 63/082,741, filed on Sep. 24, 2020.

(51) Int. Cl. C25B 1/02; C25B 11/031; C25B 11/061; C25B 11/067

(52) U.S. Cl. CPC C25B 1/02; C25B 11/031; C25B 11/061; C25B 11/067

(57) ABSTRACT

The invention disclosed herein generally contemplates novel microelectrodes and methods of preparing same.

### TECHNOLOGICAL FIELD

The invention disclosed herein generally concerns a novel microelectrode and methods implementing same.

### BACKGROUND

One of the most promising technologies for long-term renewable energy storage is water electrolysis. Water electrolysis converts electricity into chemical energy in the form of hydrogen gas (H₂). Once produced, H₂ gas can be used as fuel, for example for fuel-cell vehicles (FCVs), converted back to electricity or used in industrial chemical processes.

Electrolyzers are electrochemical devices comprising of oxygen- and hydrogen-producing electrodes and a membrane that separates the two compartments. On the hydrogen electrode, the hydrogen evolution reaction (HER) takes place, according to (left-to-right):

4H₂O+4e⁻ [symbol] 40H⁻+2H₂E₀=0V_{RHE}^{[1]} (1)

where E₀ is the reversible reaction potential. On the oxygen electrode, the oxygen evolution reaction (OER) takes place according to (right-to-left):

O₂+2H2O+4e⁻ [symbol] 4OH⁻E₀=1.23V_{RHE}. (2)

While the HER (1) is a two-electron reaction with a relatively low overpotential of <100 mV, the OER (2) is a four-electron reaction requiring a high overpotential of typically 300-500 mV. Therefore, the OER represents a kinetically challenging bottleneck that negatively impacts the overall fuel production process. It has been proposed to divide the water oxidation reaction into an electrochemical step that oxidizes the anode by conversion of Ni(OH)₂ to NiOOH (in case of a Ni-based electrode), followed by a spontaneous chemical step wherein the anode is regenerated back to its initial reduced form while producing oxygen gas [1]. Accordingly, in the first step, hydrogen is produced at the cathode according to eq. (1) (left-to-right), while a nickel hydroxide (Ni(OH)₂) anode is charged according to the following reaction (right-to-left):

NiOOH+H₂O+e⁻ [symbol] Ni(OH)₂+OH⁻E₀=1.42V_{RHE}. (3)

Although the reversible redox potential of eq. (3) is higher than the reversible OER potential, this is a one-electron reaction with a much lower overpotential, typically <100 mV. However, as the Ni(OH)₂ anode is charged to nickel oxyhydroxide (NiOOH), the polarization losses increase and eventually the process stops. To continue operation, the anode must be regenerated to its initial (reduced) state. Since the reversible potential of the Ni(OH)₂/NiOOH redox coupled is above the thermodynamic water oxidation potential (1.23 V_{RHE}), NiOOH can spontaneously transform back to Ni(OH)₂ via a chemical reaction that produces oxygen:

4NiOOH+2H2O→4Ni(OH)₂+O₂. (4)

The reaction depicted by eq. (4) has a small driving force of only 80 mV. Thus, although the anode regeneration reaction is spontaneous, it proceeds slowly at ambient temperature. To speed up the kinetics, the anode is heated to mild temperatures (typically between 90 and 130° C.), thereby thermally activating the process. This electrochemical-thermally activated (E-TAC) water splitting cycle therefore consists of two steps: (i) a high efficiency hydrogen production and Ni(OH)₂ charging step, followed by (ii) a thermally-activated and spontaneous oxygen evolution and anode regeneration step. This allows hydrogen production at nearly thermoneutral conditions (1.48 V_{RHE}) in a simple, cyclic, regenerative and robust system with high efficiency and with the prospect of safe operation and scale-up potential (FIG. 1).

This process has been demonstrated using cobalt-doped nickel hydroxide anodes synthesized by an electrochemical impregnation method. Nickel foam was used as the current collector onto which Ni_{0.9}Co_{0.1}(OH)₂ was deposited from a nickel and cobalt nitrate bath. Nickel foam has a relatively low surface area and high thermal mass. In the electrodeposited anodes discussed above, the [current collector]: [active material] mass ratio was 3:1; i.e., the nickel current collector accounted for most of the weight and cost of the anode. Moreover, a thick active layer and poor adhesion between the active layer and the nickel substrate contribute to very low material utilization.

### PUBLICATIONS

[1] B. E. Conway, P. L. Bourgault, Can. J. Chem. 1959, 37, 292.
[2] International Patent Application publication WO 2016/079746.
[3] International Patent Application publication WO 2019/180717.

### GENERAL DESCRIPTION

The most common type of Ni(OH)₂ electrodes used for battery applications are the “paste” type, wherein a paste comprising of Ni(OH)₂ powder, a conductive powder (e.g., carbon) and a polymer binder is pressed into a conductive matrix, such as a nickel mesh or nickel foam. For more advanced applications, such as super (or pseudo-) capacitors, Ni(OH)₂ electrodes are prepared by either chemical or electrochemical deposition from a solution of nickel salt onto a conductive substrate. In either case, the electrode consists of a current collecting conductive substrate coated with the active material. Despite their extensive uses, these electrodes are not without limitations, especially when applied as redox mediating anodes in decoupled water electrolysis. First, the electrodes suffer from low active material utilization, high thermal mass of the conductive core, and limited current densities. Second, the electrodes are fixed to a current collector and cannot be circulated within a system, therefore dictating a batch operation mode, similarly to battery operation wherein the electrode is first charged (electrochemically) and then discharged (chemically) in two consecutive steps. This design prohibits continuous operation, which is desired in water electrolysis.

Thus, to allow a continuous operation, wherein the electrodes may be charged and discharged without arresting or stopping the water electrolysis process, the electrodes must be movable, namely the monolithic electrode must be presented in a form that can be moved or circulated within the electrochemical cell and its activity regenerated.

The inventors of the technology disclosed herein have developed a process to pelletize the active material, such that each pellet can flow freely within the cell medium and act as a separate microelectrode. Thus, the pellets have the ability to be circulated between two continuously operated reactors, one that produces hydrogen and one that produces oxygen. However, since pellet circulation within the reactors with constant friction with system components may lead to erosion and pealing of an outer active layer, e.g., Ni(OH)₂ layer, each pellet cannot simply be in a form of a Ni(OH)₂-coated metallic particle. Moreover, a pelletized design would cover the electrically conducting metallic core with a poorly conducting Ni(OH)₂, leading to high resistance and Ohmic losses.

Accordingly, the inventors of the technology disclosed herein have further developed a capsule or a microelectrode that comprises a conducting network core, which the core integrity and function being maintained, and erosion or other friction related processes limited or diminished, by coating the conducting network core with a protective coating of an active material. The conducting network core comprises a plurality of fiber-like conductive structures that exhibit open hierarchical porosity. Each capsule or microelectrode comprising the conducting network is in itself porous, enabling flow of liquids and gases, i.e., a liquid electrolyte solution and hydrogen/oxygen gases, in and out of the capsule, while keeping structural integrity and substantially reducing mechanical damage to the inner conducting material.

The capsule is electrically conducting and connected to the internal conducting network. It is robust enough to prevent erosion and breakage of the inner porous structure, yet light enough not to add significant thermal mass to the pellet.

Thus, in a first of its aspects, the invention provides a capsule comprising a conducting network core comprising a plurality of fiber-like conductive structures exhibiting open hierarchical porosity, the capsule having a porosity enabling flow of liquid and gases therethrough.

In another aspect there is provided an electrically conductive capsule comprising an electrically conducting network core comprising a plurality of fibers exhibiting open hierarchical porosity, the capsule having a porosity enabling flow of liquid and gases therethrough.

In some embodiments, the capsule being an electrically conductive porous capsule encapsulating an electrically conductive porous network of conducting fibers, each having an open hierarchical porosity, wherein the conductive porous capsule conducts electricity to the fibers contained therein and permits liquid and gaseous communication therethrough.

In another aspect, the invention provides an electrically conductive porous capsule comprising or encapsulating an electrically conductive porous network of conducting fibers, each having an open hierarchical porosity, as defined, wherein the conductive porous capsule conducts electricity to the fibers contained therein and permits liquid and gaseous communication therethrough.

The capsules of the invention are said to comprise or “encapsulate” the conductive fiber material. The term means that the core is coated by or contained within a conductive porous capsule or a membrane or a perforated shell from all its sides, forming a continuous membrane around the core. The fibers contained in the core are provided as an electrically conductive porous network of fibers; namely a collection of fibers that are arranged as a porous network or matrix. Such network may be manufactured from a fiber mat or foam, as detailed herein.

The conducting fibers present in the cores of the capsules are composed of high surface-area conductive materials having open hierarchical porosity. Putting it differently, the fibers are elongated highly porous conductive structures having nanometric thicknesses or diameters and open hierarchical porosities. The fibers are connected to each other to form a network or matrix of fibers which, in addition to the porosity exhibited by the fibers themselves, is so arranged that pores or spaces may also be present between the fibers forming the network matrix. The porosity characterizing the fibers and fiber network or matrix may be of random distribution, sizes and shapes. Nevertheless, the porosity is relatively homogenous, permitting flow of liquids and gases through the pores.

The term “open hierarchical porosity” means that the fibers exhibit two or more types of pore systems that are of distinctly different sizes and ranges, which may be in the nanopore range, in the micron range and/or in the mesopore range.

The fibers are composed of a conductive material which may be a metallic material (e.g., in a metallic form or zero valent metal, or in an oxide or hydroxide forms or combinations thereof) or a carbonaceous material (e.g., carbon nanotubes, carbon fibers) or may be of a different conductive material such as a polymeric material. In some embodiments, the material is a metallic material which may be provided in an oxidizable or reducible form.

The metal may be any metal traditionally used in construction of electrode active materials, such including, for example, nickel, zinc, aluminum and magnesium. In some embodiments, the metal is or comprises nickel. In some embodiments, the metal is or comprises a Ni-based material.

In some embodiments, the fibers comprise or consist Ni(OH)₂. In some embodiments, the fibers comprise or consist Ni/Ni(OH)₂. In some embodiments, the fibers are core-shell structures comprising Ni cores and Ni(OH)₂ shells.

In some embodiments, the fiber material comprises nickel, optionally in combination with at least one other metal, e.g., cobalt.

In some embodiments, the fiber material comprises a metal, as defined, in combination with at least one carbonaceous material, such as CNT, carbon fibers, graphene and others.

Notwithstanding a particular fiber composition, e.g., identity of the metal, the fibers may be of different morphologies. The fibers' morphologies may range from nanosized fibers to fibers having large inner pores; from low to higher ratios of surface area to volume; from low to high pore densities; etc. The fiber morphology may vary greatly and may exhibit lamellar, nanobelt, hollow or other structural morphologies, or combinations thereof. In some embodiments, the fiber is in a form of a hollow tube. In some embodiments, the fiber is a nanobelt. In other embodiments, the fiber is a lamellar fiber. In other embodiments, the fiber is in a fibrillar.

In some embodiments, the fibers have a diameter in the nanometric range, typically in the range of 100-500 nm and a length that can reach hundreds of microns to several millimeters. As such, the fibers may be obtained, as disclosed herein, as entangled assembly or mat of fibers, which is treated, as disclosed, to obtain fibers of desired sizes that are suitable for encapsulation.

The fiber material may be prepared according to any process known in the art.

In some embodiments, the fibers utilized according to the present invention are manufactured by a process comprising treating a composite of a conductive material and a polymer binder (e.g., a metal-polymer composite) obtained, e.g., by treating fragments of an electrospun conductive material (nano) fiber, e.g., metal (nano) fibers, with a polymeric binder and treating said composite under conditions sufficient to remove the polymeric binder and to thereby obtain the conductive fiber material. The conductive fiber material may be shaped as a continuous matrix or collection of fibers that are associated to each other (shaping mats or sheets or foams), exhibiting fiber and matrix porosities.

The composite of the conductive material and polymer may be obtained by any means known in the art, provided that the conductive material, e.g., metal, is present in the composite in a highly porous form, e.g., fibrillary form, whereby the polymeric binder occupies pores in the fibrillar form. In some embodiments, the fibrillar material is provided in a form of cuttings, shreds, fragments or pieces of an electrospun metallic sheet, mat or generally metal foam that is grounded or shredded or mechanically treated to transform the mat into fragments. Once these fragments are obtained, they may be treated with the polymeric binder to form the composite.

Thus, in some embodiments, the process for manufacturing the conductive fiber material comprises
treating a composite of a conductive material, e.g., a metal in a form of fragments, and at least one polymeric binder under conditions sufficient to remove the polymeric binder and obtain metallic (nano) fibers having open hierarchical porosity.

As used herein, the conditions sufficient to remove the polymeric binder and convert the metallic fibers into porous structures, as disclosed, include thermal treatment, reductive treatment, dissolving solutions and others, as may be the case, and depending, inter alia, on the composition of the composite, the type of polymer binder used, and others. In some embodiments, the reductive conditions involve use of a reducing agent such as hydrogen gas.

In some embodiments, the process comprises
treating conductive (nano) fibers with at least one polymeric binder to form a composite of the conductive (nano) fiber material and the at least one polymer.

In some embodiments, the fibers are electrospun.

In some embodiments, the conductive material is a metal.

In some embodiments, the metallic conductive material is in a form of a mat or foam of (nano) fibers.

In some embodiments, the process comprises
forming (e.g., by electrospinning) a metal fiber mat or sheet or foam;
grinding the foam to obtain fragments of said mat, sheet or foam;
treating said fragments with a polymeric binder to obtain the metal-polymer composite;
treating the composite under conditions sufficient to remove the polymeric binder and obtain a plurality of conductive fibers having open hierarchical porosity.

The hierarchical structure of the fibers may be modified or altered by forming the initial (nano) fiber foam by co-electrospinning with a polymer fiber of a larger diameter (i.e. >1 micron). These polymeric fibers create larger channels in the metal fiber bed, once the fiber compact is burned and reduced to produce the fiber electrode. Such channels will reduce mass transport limitation to the core of the fibers within the individual pellets.

Thus, in a step of forming (e.g., by electrospinning) a conductive (nano) fiber foam, a solution comprising a precursor of the conductive material or of the material and a polymer or a solution comprising the precursor or the conductive material and a different solution comprising the polymer may be electrospun to produce the foam, as further demonstrated in FIG. 1.

In a process of the invention, the conductive material, e.g., metal, may be transformed from one oxidation state to another and/or from one form into the other. A non-limiting depiction of a process for the production of a nickel electrode according to the invention is provided in FIG. 2.

As depicted in the example of FIG. 2, a solution of a nickel precursor optionally containing another metal precursor, e.g., a cobalt precursor, and/or a polymer, is subjected to elecrospinning, forming a green nanofiber (NF) mat. Next, the mat is calcined, oxidizing the nickel into nickel oxide (NiO). The NiO mat is ground, and the resulting powder is mixed with a polymer binder and pressed, forming a pellet. The pellet is then reduced in a hydrogen environment to produce a porous metallic nickel pellet composed of the porous nickel nanofibers. To form the active Ni(OH)₂ surface layer, the nickel pellet is connected as the working electrode in an electrochemical cell with a warm (˜50° C.) alkaline electrolytic solution and subjected to chronopotentiometric oxidation/reduction cycles.

Thus, for manufacturing a Ni/Ni(OH)₂ fiber material, the process comprises
electrospinning a solution comprising at least one nickel precursor and optionally at least another metal precursor, e.g., a cobalt precursor, to provide a fiber mat comprising the at least one nickel precursor and optionally the at least another metal precursor;
transforming the nickel precursor in said mat or foam to nickel oxide (NiO) (and said at least another metal precursor to a metal form) to provide a NiO mat or foam;
grinding the NiO mat or foam into a powder to obtain fragments of the NiO fibers and mixing with a polymer binder to form a composite; the composite may be optionally pressed into a pellet form;
transforming the NiO in said composite into nickel metal (NiO) under conditions permitting removal of the polymeric binder to provide a highly porous nickel (nano) conductive fiber; and
transforming at least some of the nickel metal (NiO) in the (nano) fibers to Ni(OH)₂ to thereby afford the Ni/Ni(OH)₂ fibers.

In a similar fashion, other metals, metal precursors and conditions may be used to manufacture electrode materials according to the invention.

The fibers manufactured may be used as metal foams or as pellets comprising a plurality of elongated fibrillar structures, which porosity being defined by the distance between the metal regions, as depicted in examples provided herein.

The capsule of the invention is structured of a porous or perforated shell enclosure, which may be metallic, and which contains the fibers and protects the fibers from mechanical degradation, e.g., erosion. The capsule may be made by a variety of methodologies. For example, the capsules may be made by stamping a thin, perforated metal sheet; two such half capsules (e.g., with hemispherical ends and straight cylindrical sections, similar to medical pills) may be filled with fibers and subjected to burn-off of residual organics, reduction of the metal, e.g., nickel, oxide to metal, and permanently attach the fibers to the inner capsule walls, thus securing electrical conductivity from the capsule wall to the inner fibers. The final attachment of the fibers to the capsule walls may be achieved by a variety of thermal treatments, for example by rapid temperature processing (RTP) using, e.g., IR radiation.

A scheme describing this process is shown in FIG. 3

Alternatively, the capsule can be made from a conductive polymer by, e.g., injection molding. The capsules may thereafter be filled with the metallic nanofibers after their reduction.

Thus, the invention further provides a process for manufacturing an electrically conductive capsule according to the invention, the process comprising filling a capsule of at least one electrically conductive material, e.g., a metal or a conducting material such as a conducting polymer, with a conductive fiber material under conditions securing electrical conductivity between the capsule and the fiber contained therein.

As used herein, the term “fill” or any lingual variation of the term, when in reference to introducing the fibers into the capsules, does not suggest complete filling or packing of the capsule. The term simply suggests the introduction of an amount of the fiber material into the capsule, wherein the amount is determined, inter alia, by the size of the capsules, the conductive materials used and other considerations.

In a process of the invention, the capsule, independent of its final shape, may be formed of two halves of the capsule final shape that are brought together and closed. Alternatively, the capsule may be formed of a single shaped structure that can be filled and thereafter closed.

In some embodiments, the capsule is formed of two halves, each with hemispherical ends and straight cylindrical sections, providing secure attachment and closure.

Irrespective of the capsule form and mode of construction, once filled with the fiber material, the capsule is treated under conditions achieving electrical conductivity between the capsule and its content. Electrical conductivity may be achievable by attachment of the fibers within the capsule to the capsule inner walls. While not all fibers within the capsule need to be attached, attachment of at least the peripheral fibers is needed. The attachment may be achievable by thermally treating the capsules. In some embodiments, the attachment is achievable by rapid temperature processing (RTP), e.g., using IR radiation, as disclosed herein.

A conductive capsule of the invention may be regarded a “microelectrode”. As used herein, the term refers to an electrode that is of appropriate size and which is electrically conductive, perforated to allow passage of liquids and gasses and mechanically robust to prevent erosion. The small diameter of the microelectrodes makes their active surface area per electrode volume or weight particularly large. In some embodiments, the surface area per weight of microelectrodes of the invention is between 5 m²/gr 100 m²/gr or several hundreds.

Typically, the microelectrodes have a size or a cross-section of several microns (between 1 and 10 microns) to several millimeters. In some embodiments, the cross-section size is between 1 microns and 0.1 mm or between 10 microns and 2 millimeters. The capsule may have any shape and thus the indicated sizes refer to the capsule longest axis. In some embodiments, the capsule is in a shape of a sphere, a cube, an ellipsoid, a polygonal and others. In some embodiments, the capsule is spherical.

The capsule and/or the fiber material contained therein may be composed of a redox-active material or an active material that has the ability to undergo reversible oxidation-reduction, under different conditions, for example different temperatures and/or different electrical bias. The active material may be the material from which the capsule shell and/or the fibers are made from or a material which coats a region of the capsule and/or fiber surface. The redox active material may be in a reduced form (prior to oxidation) or in an oxidized form or may be in any intermediate state (e.g., partially oxidized, partially reduced). When in a reduced form or a partially reduced form, the redox-active material is capable of undergoing oxidation to revert back to (or generate) the oxidized or partially oxidized form and vice versa.

In some embodiments, the electrically conductive capsule is made of a conductive material that is same or different from the material of the conducting fibers contained therein. In some embodiments, the capsule conductive material is of comprises nickel. In some embodiments, the capsule conductive material is or comprises Ni/Ni(OH)₂. In some embodiments, each of the conductive fibers and the capsule conductive material is or comprises Ni, Ni(OH)₂ or Ni/Ni(OH)₂. In some embodiments, the capsule material is different or does not comprise nickel. In some embodiments, both the fibers and the capsule are or are comprised nickel, e.g., Ni/Ni(OH)₂.

In a system of the invention utilizing capsules of the invention, wherein the system is, for example, for generation of hydrogen and oxygen gases, the electrode is provided in a form of a plurality of microelectrodes of the invention dispersed in a medium.

Thus, the invention also provides a system for generation of hydrogen and/or oxygen gas, the system comprising a plurality of microelectrodes according to the invention, dispersed in a medium. The system may be one which comprises an electrochemical device that is configured for generating gases.

Also provided is a system for generation of gases, the system comprising an electrochemical device comprising a plurality of microelectrodes of the invention, the microelectrodes being of at least one redox-active material.

In some embodiments, the electrochemical device is a reactor or a plurality of reactors arranged and configured for generating a gas. In some embodiments, the device is an electrochemical thermally activated chemical cell (E-TAC). As known in the art, an E-TAC system [2,3] enables alternate production of hydrogen gas and oxygen gas. In accordance with the technology, hydrogen gas is generated in an electrochemical step on a cathode electrode while charging the anode electrode, by water reduction, whereas oxygen gas is generated in a spontaneous chemical step during regeneration of the anode. In a modified ETAC system according to the present invention, microelectrodes of the invention may be utilized to replace the active anode electrode.

The invention further provides an electrochemical device for generation of a gas by utilizing microelectrodes of the invention (e.g., having an oxidized form and a reduced form), the device is adapted and operable to convert the microelectrodes from an oxidized form to a reduced form.

In another aspect there is provided a medium of an electrochemical cell comprising a plurality of capsules, e.g., microelectrodes according to the invention. In some embodiments, the medium is water-based or an aqueous medium or an electrolyte solution, which comprises metal electrolytes such as Li, Na, K, Rb, Cs, Ca, Sr and Ba. In some embodiments, the metal is an alkali metal. In some embodiments, the electrolyte comprises a metal hydroxide. In some embodiments, the metal hydroxide is NaOH or KOH. In some embodiments, the aqueous solution is carbonate-bicarbonate buffer electrolyte.

Similarly, the invention provides a substrate having a surface region associated with a microelectrode or an assembly of microelectrodes according to the invention.

The invention also provides an electrochemical cell comprising an electrode assembly of a cathode and an anode, wherein the anode is provided as a microelectrode according to the present invention. In some other implementation, the cathode is provided as a microelectrode of the invention.

In an electrochemical cell of the invention, the anode (or cathode) being the microelectrodes is immersed in the electrolyte or ionically conductive solution or medium. The cathode and the microelectrodes constituting the anode are electronically separated by ionically conductive solution or medium and the electrochemical reaction takes place only when they are in contact with an electron conducting electrode.

Also provided is an anode or a cathode electrode in a form of a microelectrode of the invention.

Further provided is a device which comprises a microelectrode according to the invention, the device being optionally selected from electric cells, electric furnaces, thermionic tubes, gas-discharge devices, and semiconductor devices, the device utilizing a microelectrode according to the invention.

In some embodiments, the device is an electrochemical cell (such as a battery, a flow battery, a fuel cell, an electrolyzer and a supercap).

The invention further provides a conductive material in a form of a fiber or an elongated structure having open hierarchical porosity, as disclosed herein, for use in constructing a capsule or a microelectrode according to the invention. The fibers are as disclosed herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides a schematic illustration of the E-TAC water splitting cycle. The electrochemical hydrogen generation step (Step 1, left) is carried out in a cold (25° C.) alkaline solution. Then, the chemical oxygen generation step (Step II, right) is carried out in a hot (95° C.) alkaline solution at open circuit.

FIG. 2 provides a schematic depiction of an exemplary process for manufacturing a nickel electrode material according to the invention.

FIGS. 3A-C provide pelletized nickel hydroxide electrodes. (FIG. 3A) the conventional nickel foam substrate (1) is broken down into small discrete units (pellets, 2). (FIG. 3B) zoom-in on the pellet, showing a porous internal conductive matrix (3), encapsulated by a conductive perforated protective metal sheet (4). (FIG. 3C) zoom-in on a single porous nickel nanofiber, a possible type of morphology for the inner matrix. The metallic fiber can be oxidized electrochemically in an alkaline solution, forming a core/shell Ni/Ni(OH)₂ structure.

FIGS. 4A-4G present the electrode synthesis process according to the invention. FIG. 4A) Electrospun NiAc-PVP “green” fiber sheet. FIG. 4B) Firing schedule of the mat. FIG. 4C) NiO fiber mats after calcination. FIG. 4D) NiO nanofiber coarse powder. FIG. 4E) NiO nanofiber powder and PPC paste. FIG. 4F) Metallic nickel porous nanofiber substrate. FIG. 4G) Electrodeposited Ni(OH)₂ electrode on a nickel foam substrate.

FIGS. 5A-C are HRSEM micrographs of NiAc-PVP “green” nanofibers under various magnifications. FIG. 5A) ×1,000, FIG. 5B) ×10,000, and FIG. 5C) ×50,000.

FIGS. 6A-B are HRSEM micrographs of nickel oxide nanofibers after calcinations. FIG. 6A) low-, and FIG. 6B) high-magnification.

FIGS. 7A-B are HRSEM micrographs of nickel oxide nanofibers after grinding and binder addition. FIG. 7A) low-, and FIG. 7B) high-magnification.

FIGS. 8A-D are HRSEM micrographs of the pressed and reduced nickel substrate and nanofibers. FIG. 8A) low-, FIG. 8B) and FIG. 8C) medium-, and FIG. 8D) high-magnification.

FIGS. 9A-B depict Ni(OH)₂ layer growth (FIG. 9A) and the corresponding change in electrode charge capacity (FIG. 9B) with layer formation cycles. The charge capacity was estimated using potentiostatic charge/discharge cycles at 1.48 V_{RHE}/1.23 V_{RHE} for charging/discharging durations of 100, 200, 400, 800, 1600, and 3200s in 5M KOH electrolyte at ambient temperature.

FIGS. 10A-B provide (FIG. 10A) HRSEM image of an undoped Ni/Ni(OH)₂ NFA after layer growth by E-TAC cycling. (FIG. 10B) diffractograms of an undoped Ni/Ni(OH)₂ NFA formed in situ by E-TAC cycles after different preparation stages: as-prepared NF nickel substrate (red line), after aging for 2 h in 5M KOH at 90° C. (green line), after 100 E-TAC cycles of 100s charge/100s regeneration (blue line), and after final characterization in a full E-TAC test (black line).

FIG. 11 provides X-ray diffractograms of a Ni/Ni(OH)₂ nanofiber anodes. Diffractograms of a Ni/Ni(OH)₂ NFA formed by galvanostatic cycling after different preparation stages: as-prepared NF nickel substrate (red line); after aging for 2 h in 5M KOH at 90° C. (green line); after active layer growth by galvanostatic cycling at 55° C. (blue line); and after final characterization in a full E-TAC water splitting test (black line). The dashed vertical lines indicate the position and relative intensities of Bragg reflections of metallic nickel (JCPDS 00-004-0850, green), NiO (JCPDS 01-071-4750, red) and β-Ni(OH)₂ (JCPDS 00-059-0462, black).

FIGS. 12A-C are HRSEM images of undoped Ni/Ni(OH)₂ nanofiber anodes. (FIG. 12A) As-prepared Ni nanofiber substrate. (FIG. 12B) Ni/Ni(OH)₂ nanofiber anode after layer growth by galvanostatic cycling. (FIG. 12C) Ni/Ni(OH)₂ anode after E-TAC water splitting tests.

FIGS. 13A-D depicts elemental distribution in a cobalt-doped nanofiber anode. HRSEM micrograph (FIG. 13A) and the corresponding qualitative EDS mapping (FIGS. 13B-C) of a cobalt-doped Ni/Ni_{0.9}Co_{0.1}(OH)₂ nanofiber anode prepared by galvanostatic cycling.

FIGS. 14A-B show surface area and pore size distribution of a Ni/Ni(OH)₂ nanofiber anode. (FIG. 14A) B.E.T N₂-absorption isotherms before and after Ni(OH)₂ active layer growth on a nanofiber nickel substrate (red and blue curves, respectively). (FIG. 14B) B.J.H N₂-desorption pore volume distribution before and after Ni(OH)₂ active layer growth by galvanostatic cycling. The inset shows the B.J.H plot before layer growth

FIG. 15 provides cyclic voltammograms of Ni/Ni(OH)₂ nanofiber anodes with and without cobalt. CVs of an undoped Ni/Ni(OH)₂ NFA (red) and a cobalt-doped Ni/Ni_{0.9}Co_{0.1}(OH)₂ NFA (blue) measured at a scan rate of 0.05 mV/s. The red and blue circle data series represent the steady-state Tafel plots for the undoped and doped NFAs respectively. All tests were carried out in an aqueous solution of 5M KOH at ambient temperature. The inset shows a magnification of the steady-state Tafel area.

FIGS. 16A-D provide comparison of the regenerated charge and current density of an undoped Ni/Ni(OH)₂ nanofiber anode (red lines), a doped Ni/Ni_{0.9}Co_{0.1}(OH)₂ nanofiber anode (blue lines), and a doped Ni_{0.9}Co_{0.1}(OH)₂ electrodeposited anode (green lines) in E-TAC water splitting tests. Charging was carried out by applying a constant potential of 1.48 V_{RHE} (full lines) or 1.43 V_{RHE} (dashed lines) in 5M KOH aqueous solution at ambient temperature for a set duration, and regeneration was carried out by dipping the charged anode in 5M KOH aqueous solution at 95° C. for the same duration. The comparison is shown on the basis of the anode's volume, geometric area, total weight and active layer weight for E-TAC water splitting tests with charging/regeneration durations of 100s (FIG. 16A), 200s (FIG. 16B), 400s (FIG. 16C) and 800s (FIG. 16D). In each plot, all values are normalized by the highest values in that category, which are listed in Table 2. The center and circumference of each square represent relative values of 0% and 100%, respectively, and the inner gridlines are spaced at 20% intervals

FIGS. 17A-D show the effect of temperatures parameters on NFE microstructure. HRSEM images of nickel nanofiber anodes prepared at an ES voltage of 14 kVs with various maximum sintering temperatures of 500° C. (FIG. 17A), 600° C. (FIG. 17B) and 700° C. (FIG. 17C), and at 500° C. with a higher ES voltage of 26 kVs (FIG. 17D).

### DETAILED DESCRIPTION OF EMBODIMENTS

### Experimental

Electrospun Ni and NiCo Substrate Synthesis

Nickel acetate tetrahydrate with and without cobalt acetate (Ni:Co=0.9:0.1) was dissolved (10.6 wt. %) in acetic acid and ethanol (6:4 by wt.). The solution was stirred and filtered (0.22 μm), resulting in a light-green clear solution.

Next, polyvinyl pyrrolidone was added (8.8 wt %) and stirred at ambient temperature to achieve a final viscosity of 500-650 cPs.

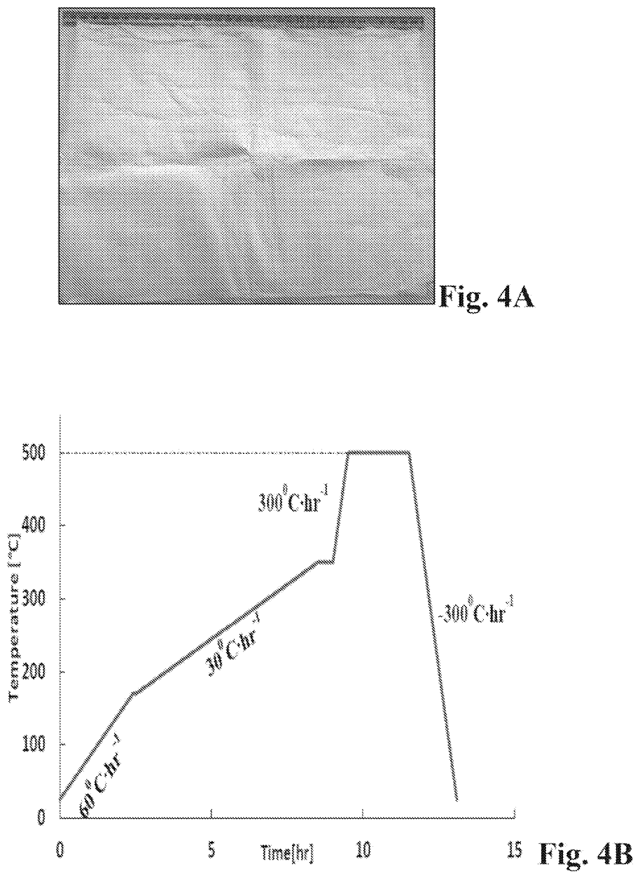

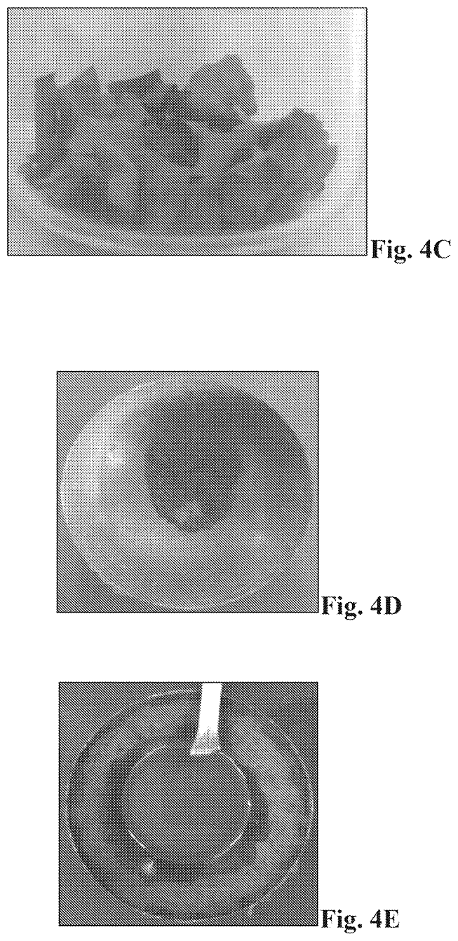

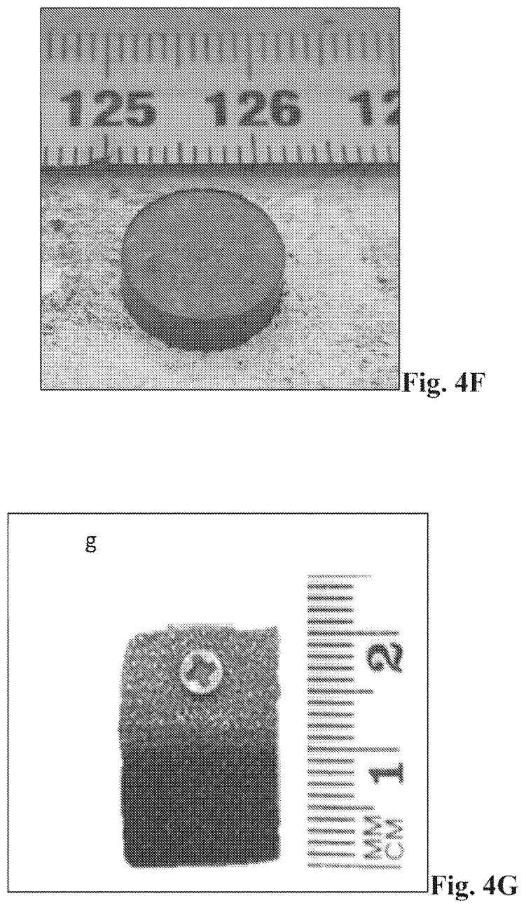

The solution was electrospun (21-gauge needle, 17 kV, 1.25 ml/h, 15 cm WD), resulting in green NiAc-PVP fiber mats (FIG. 4a). The green fiber mats were then thermally treated in air (FIG. 4b) and the Ni was oxidized to NiO. The NiO mats (FIG. 4c) were ground to a powder (FIG. 4d), and mixed with a solution of Poly(propylene carbonate) 10.5 wt. % to form a paste (FIG. 4e). The powder-binder composite paste was then pressed into a mold at˜3000 kgf to form a pellet having a diameter of ˜1.1 cm (FIG. 4F). Each pellet was heated in a tubular furnace under reducing atmosphere (5 vol. % H₂/N₂, 45 cc/min), to decompose the polymer and reduce the NiO to metallic Ni, and to sinter the fibers.

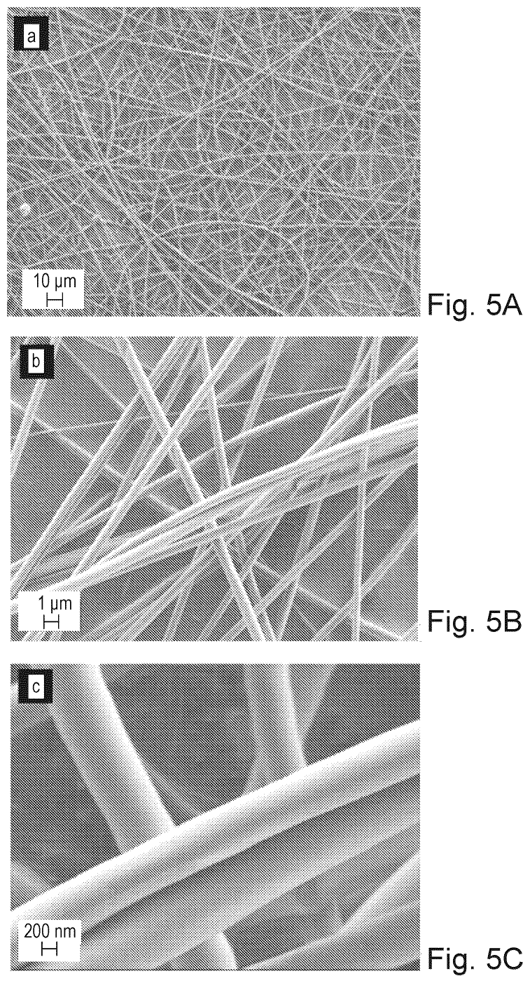

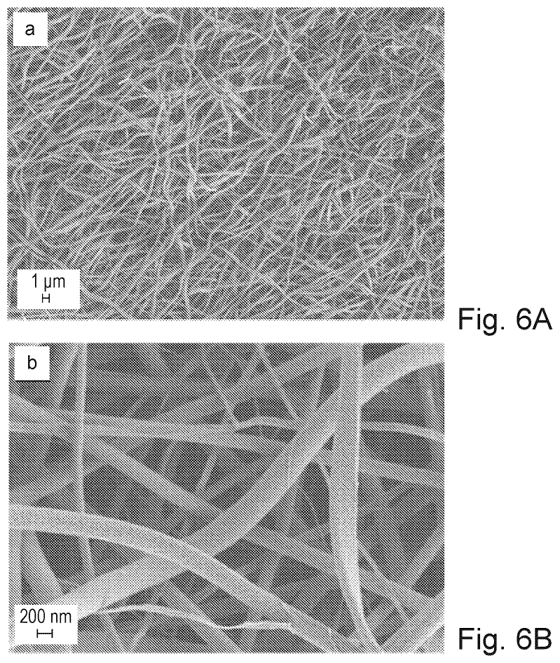

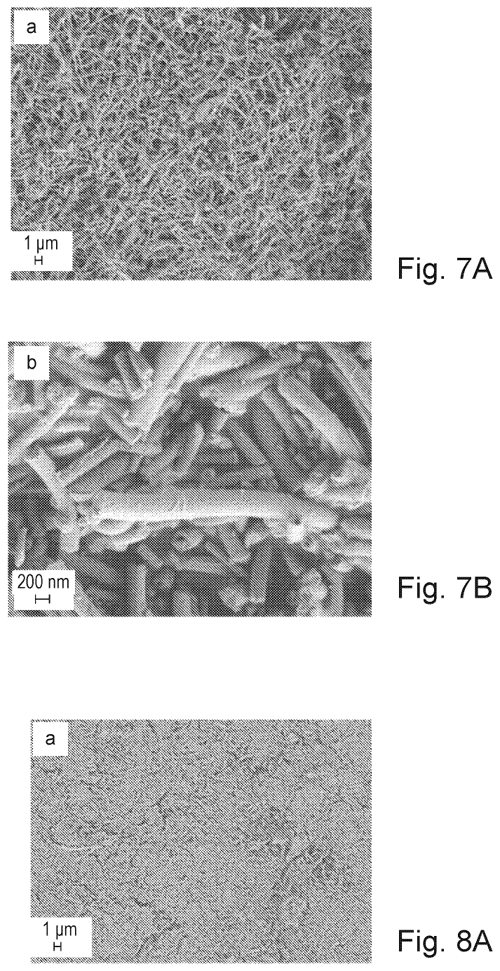

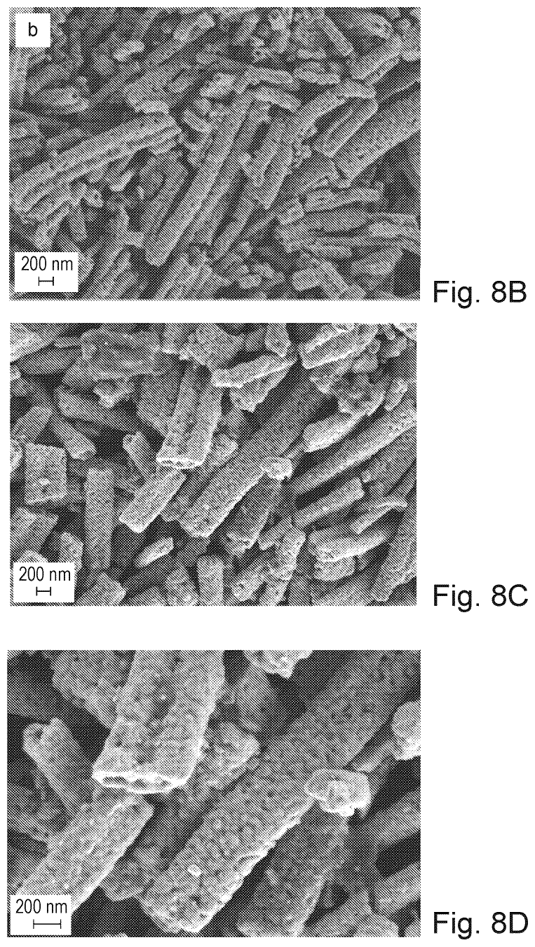

SEM images of the green fibers, the calcined fibers, the ground fibers and the final fibers after reduction are presented in FIGS. 5A-C, FIGS. 6A-B, FIGS. 7A-B, and FIGS. 8A-D, respectively. Qualitative mapping and quantitative elemental analysis was carried out by EDS (Oxford SDD EDS), and are summarized for the doped and undoped electrodes in Tables 1 and 2, respectively. The total porosity of the as-prepared Ni substrates was calculated as 74-75%.

TABLE 1
Compositional EDS analysis of cobalt-doped nickel
nanofibers after calcination and reduction.

| Sample | Composition (wt. %) | Composition (at. %) |
|---|---|---|
| Cobalt-doped Ni fibers | Ni: 87.46% | Ni: 83.21% |
| (reduced) | Co: 10.6% | Co: 10.05% |
| | O: 1.93% | O: 6.74% |
| Cobalt-doped Ni fibers | Ni: 89.31% | Ni: 86.23% |
| (reduced) | Co: 9.33% | Co: 8.98% |
| | O: 1.35% | O: 4.80% |

TABLE 2
Compositional EDS analysis of nickel nanofibers
after calcination and after reduction.

| Sample | Composition (wt. %) | Composition (at. %) |
|---|---|---|
| Calcinated NiO fibers | Ni: 78.49% | Ni: 49.86% |
| | O: 21.51% | O: 50.14% |
| Reduced Ni fibers | Ni: 98.67% | Ni: 95.29% |
| | O: 1.33% | O: 4.71% |

Ni(OH)₂ Layer Growth by Oxidation/Reduction Cycles

In order to grow the active Ni(OH)₂, the Ni pellet was connected as the working electrode (WE) to a potentiostat in in 5M KOH aqueous electrolyte solution (˜50° C.), and subjected to 60 chronopotentiometric oxidation-reduction cycles at ±150 mA/cm² up to ±200 C/cm² or up to 1.55 V (during oxidation) and 1 V_{RHE} (during reduction).

Every few cycles, the electrode was dried and weighed to calculate the percent of nickel atoms oxidized to Ni(OH)₂ (eq. 1):

$$\% Ni oxidized to Ni {( OH )}_{2} = \frac{\frac{{m}_{i}}{M {w}_{Ni}} - \frac{Δ m}{{Mw}_{{( O H )}_{2}}}}{\frac{{m}_{i}}{M {w}_{Ni}}} \qquad ( 1 )$$

where mᵢ is the initial pellet mass, m_{f} is the final pellet mass, and Δm is the weight gain.

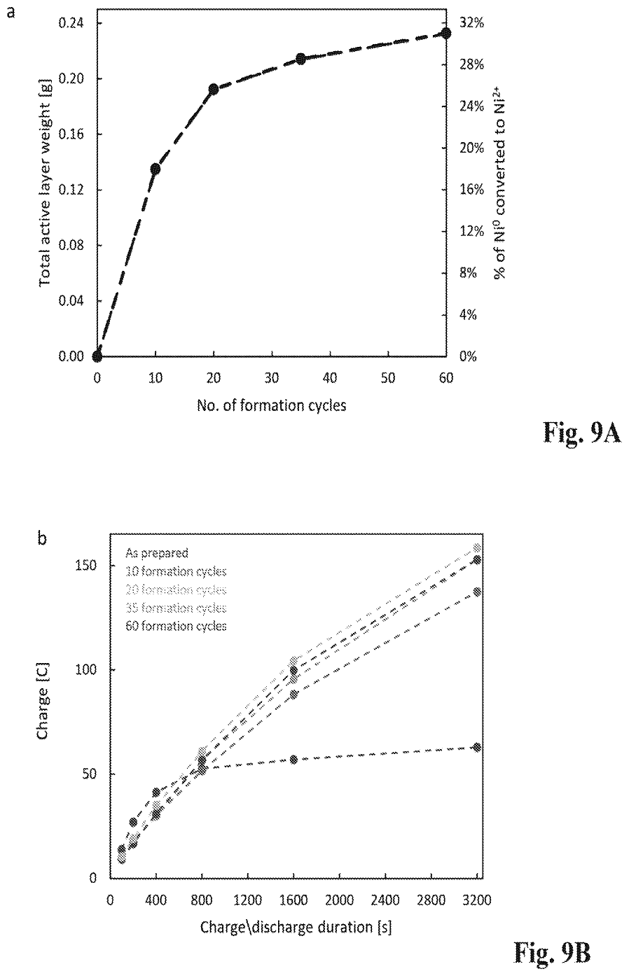

To characterize the added charge capacity, the pellet was also subjected to chronoamperometric redox cycles. FIG. 9B shows the change in the electrode's charge capacity with layer growth cycles. By the end of the process, the electrode's weight was increased by 18% relative to the initial substrate weight, corresponding to a conversion of 30% of the Ni atoms to Ni(OH)₂.

In-Situ Layer Growth

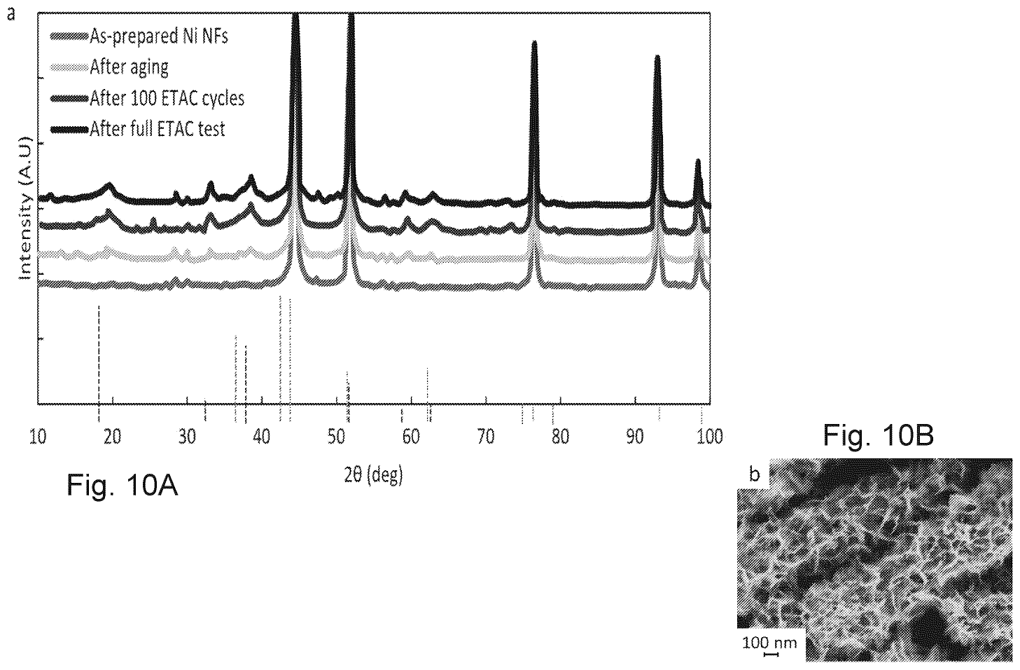

The Ni(OH)₂ can also be grown in-situ during E-TAC water electrolysis without preliminary layer growth. An as-prepared Ni pellet was connected as the WE to a potentiostat in a three electrode configuration (Hg/HgO reference electrode) in 5M KOH aqueous electrolyte at ambient temperature. In this setup, the pellet was subjected to repeated E-TAC cycles with charging at 1.48 V_{RHE} for 100s and regeneration in a hot (95° C.) 5M KOH solution for 100s. X-ray diffractograms and SEM images of the resulting Ni(OH)₂ layer are presented in FIGS. 10A-B.

Electrochemical Characterization and E-TAC Water Splitting Tests

Electrochemical tests were carried out in a three-electrode system, with the either the nanofiber anode (NFA) or an electrochemically deposited anode (EDA) as the working electrode, with a platinum foil (1 cm²) counter electrode, and an Hg/HgO/1M NaOH reference electrode in 5M KOH. Electrodeposited anodes were prepared as described elsewhere.

E-TAC water splitting tests were carried out by first charging the pellet anode at 1.48/1.43 V_{RHE} in 5M KOH solution at ambient temperature (for 100, 200, 400 or 800s), and then regenerating the pellet anode by dipping it in a hot (95° C.) 5M KOH solution for the same duration. Stability tests were carried out with 100s charge/regeneration cycles. In addition, the anode was also subjected to E-TAC cycles with short regeneration times, wherein the charging duration varied between 100 and 800s, but the regeneration duration was kept constant at 100s.

### Results and Discussion

Phase and Morphology Characterization

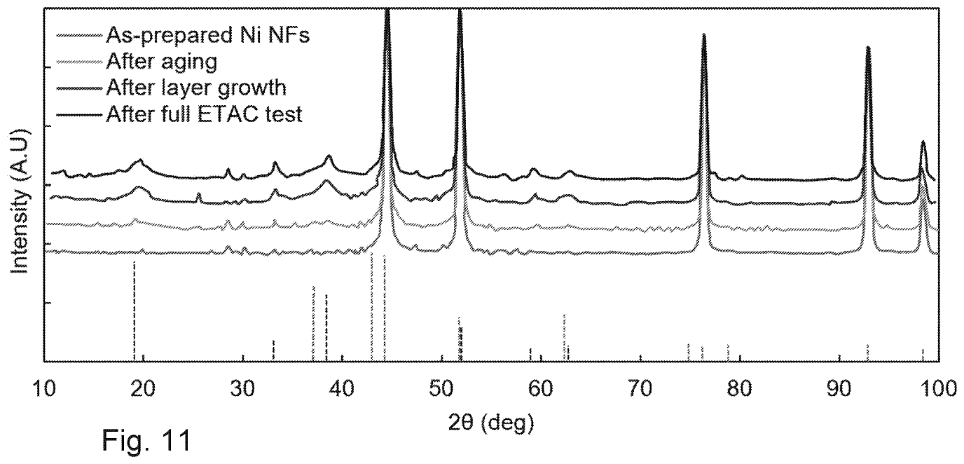

FIG. 11 shows X-ray diffractograms of the NFA in different stages of preparation displaying Bragg reflections of metallic nickel for the as prepared pellet, and Bragg reflections of β-Ni(OH)₂ after layer growth and E-TAC tests.

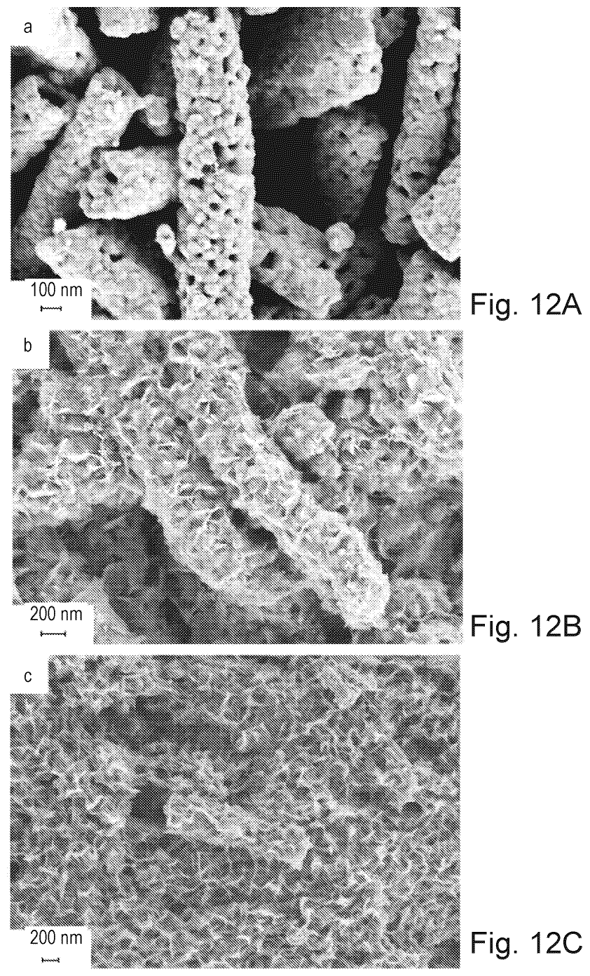

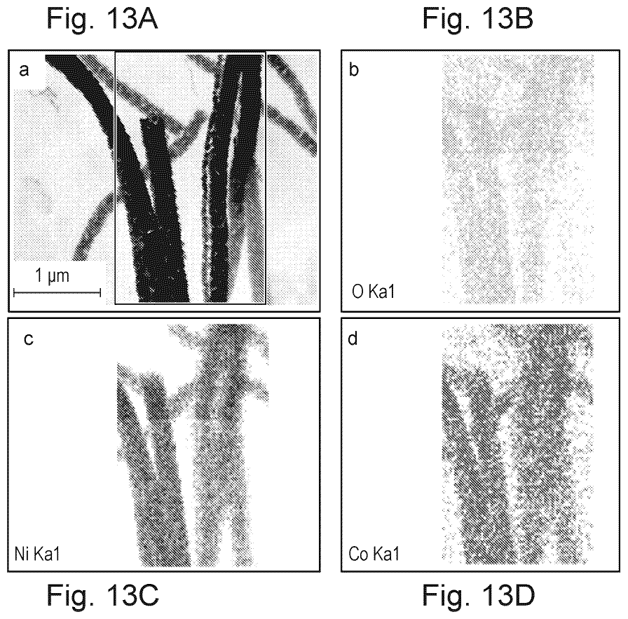

FIG. 12 presents high-resolution SEM micrographs of the Ni/Ni(OH)₂ nanofibers before and after active layer growth. The as-prepared pellet comprised of short (up to ˜1 μm) highly porous nanofibers with an average diameter of ˜250 nm (overall porosity=˜75%). After layer growth the pellet comprised of fibers with a highly porous “coral” structure comprising of thin sheets (20-50 nm). In the cobalt-doped anodes, cobalt was distributed homogenously along the fibers, as shown in FIG. 13.

FIG. 13 shows EDS maps of the as-prepared NiCo fibers (10 wt. % cobalt, Table 2), displaying a homogeneous distribution of cobalt within the nickel fibers.

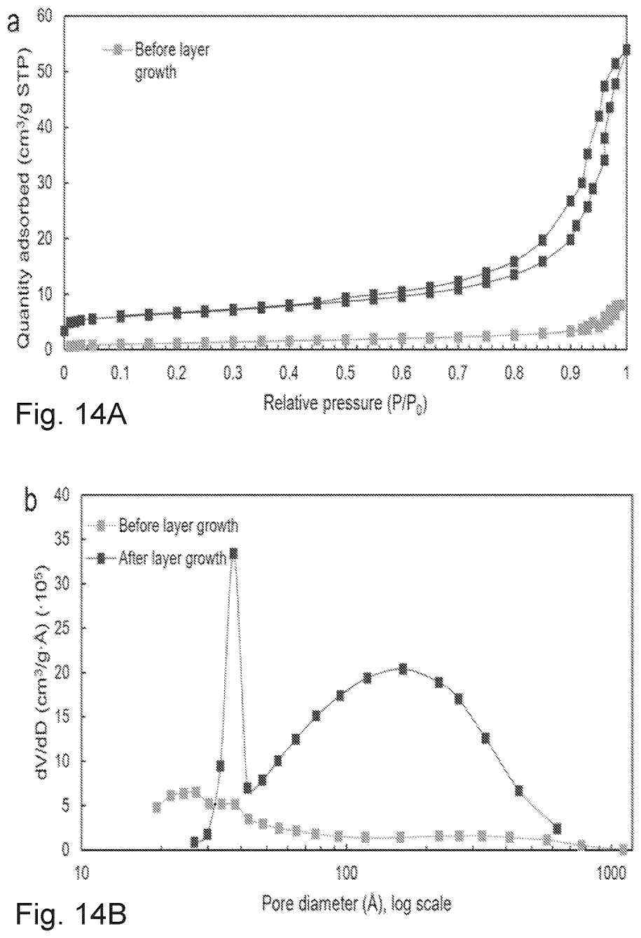

The surface area of the pellets was measured using BET (FIG. 14). The BET surface area of the as-prepared pellet was 4.5 m²/g (FIG. 14A), two orders of magnitude higher than the surface area of the nickel foam used for the electrochemically deposited anodes (˜0.01 m²/g). The surface area increased to 22.9 m²/g following layer growth. A bimodal mesopore size distribution was observed as shown in FIG. 14B, with two peaks at pore diameters of approximately 3 and 30 nm before layer growth, and 3 and 16 nm after layer growth. Additionally, the total pore volume of small pores (with diameter <100 nm) increased by a factor of 6.5 after Ni(OH)₂ layer growth. This can be attributed to the growth of the porous Ni(OH)₂ layer, as shown in FIG. 12. Overall, a hierarchical meso/macro porous structure with a high surface area was obtained.

Electrochemical Characterization of Ni/Ni(OH)₂ and Ni/Ni_{0.9}Co_{0.1}(OH)₂ Nanofiber Anodes

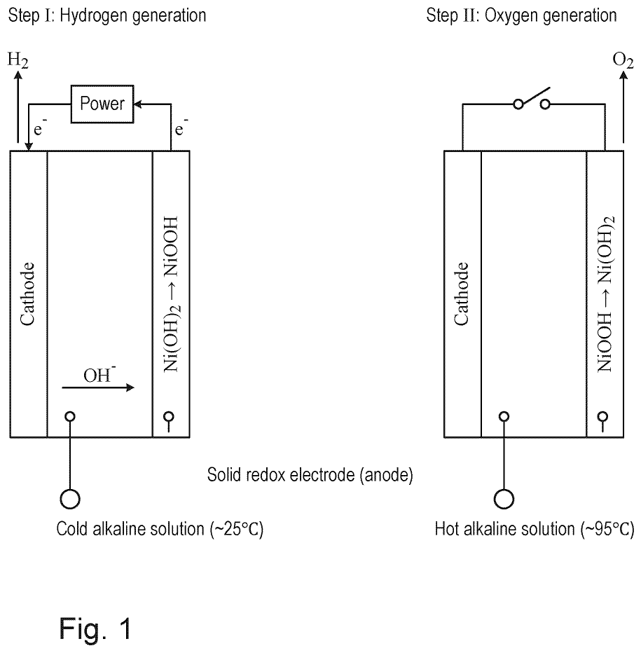

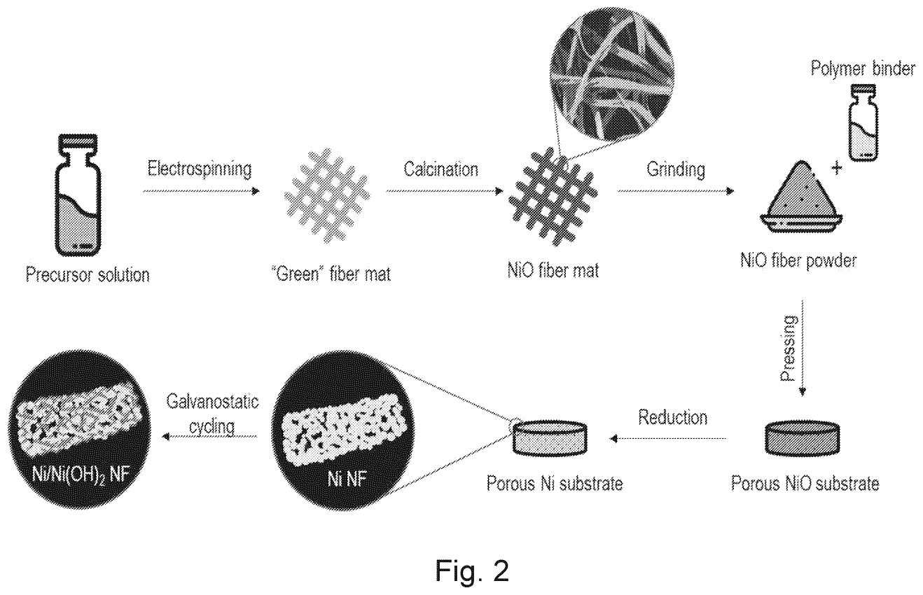

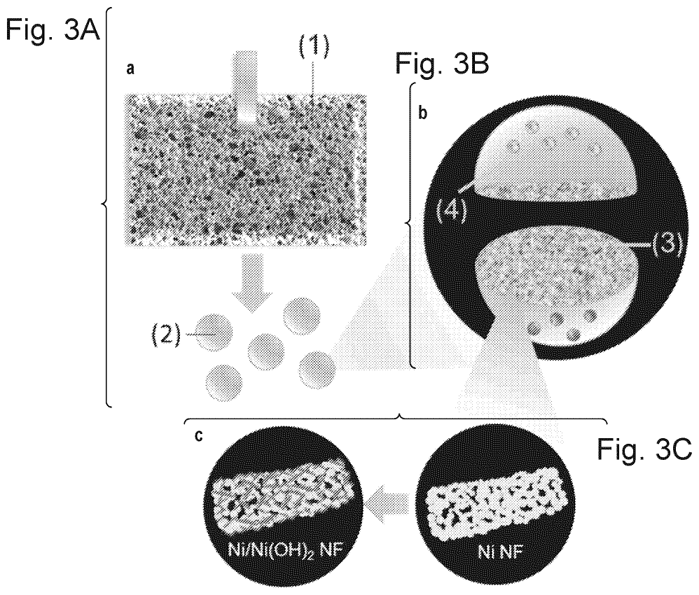

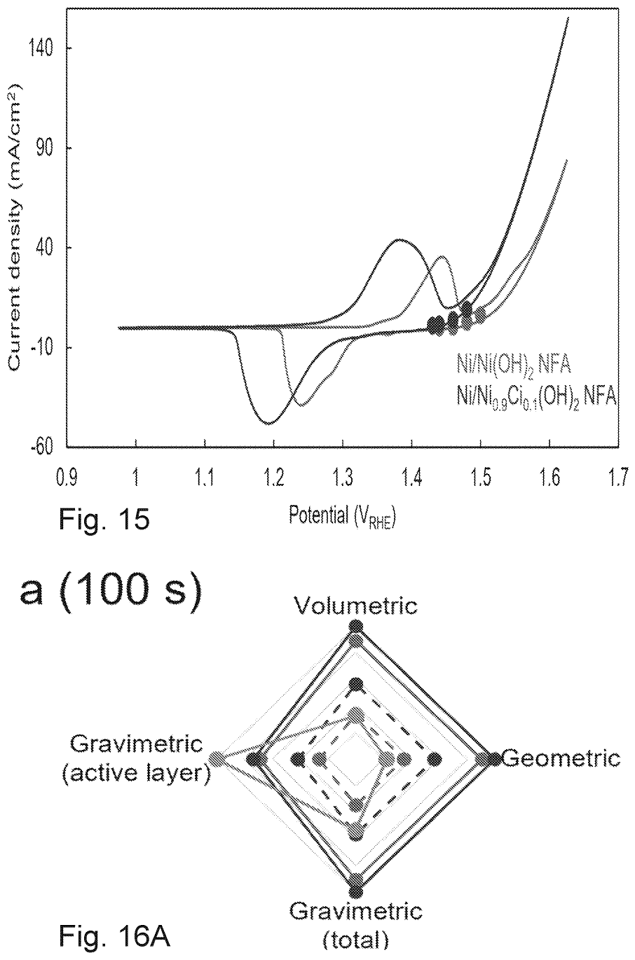

Core-shell electrospun nickel hydroxide electrodes were prepared to serve as redox anodes for decoupled E-TAC water splitting (FIG. 1). To characterize their electrochemical properties, the anodes were subjected to cyclic voltammetry (CV) scans. The CV scan of a Ni/Ni(OH)₂ NFA (FIG. 15) displayed a single redox wave centered around 1.34 V_{RHE}, which provides a good approximation for the anode's reversible redox potential)(E⁰). The reversible potential is an important electrochemical property of Ni(OH)₂ anodes for E-TAC water splitting, as the cell voltage during the first (hydrogen generation) step is directly related to the Ni(OH)₂ oxidation potential according to: V_{cell}=E_{anode}−E_{cathode}+ΣiR=(E⁰_{anode rxn}+η_{anode})−(E⁰_{cathode rxn}−η_{cathode})+ΣiR (eq. 1); where V_{cell} is the cell voltage, E is the applied potential, E⁰ is the reversible potential, η=E−E⁰ is the overpotential and ΣiR is the sum of all the series resistance Ohmic losses. Thus, a low anodic redox potential alongside a minimal anodic overpotential contribute to a high voltage efficiency (1.48/V_{cell}).

Additionally, since parasitic oxygen evolution may take place upon charging the anode to a high state of charge (SOC), a lower redox potential shifts the anode charging reaction away from the OER and enables charging the anode to higher SOCs without parasitic oxygen evolution. To evaluate the OER rate at the NFAs, the anodes were subjected to chronoamperometric measurements between 1.43 and 1.48 V_{RHE} By allowing the current to stabilize, a distinction could be made between the pseudo-capacitive Ni(OH)₂ oxidation current and the steady-state OER Faradaic current. The corresponding steady-state Tafel plot for the OER Faradaic current at the Ni/Ni(OH)₂ NFA is plotted in FIG. 15. As can be seen, the onset potential for the OER at the Ni/Ni(OH)₂ NFA (taken at j_{OER}=1 mA/cm² from the exponential fit) was 1.47 V_{RHE}, about 130 mV above the reversible redox potential of the Ni(OH)₂/NiOOH couple (1.34 V_{RHE}), and 30 mV above the peak of its oxidation wave (at a potential of 1.44 V_{RHE}) Thus, this anode can be oxidized at ambient conditions without concurrent oxygen evolution.

The reversible redox potential, as well as the charging and discharging overpotentials, are also affected by incorporation of various additives and dopants into the Ni(OH)₂ anode. Specifically, cobalt is known to shift the Ni(OH)₂ redox potentials cathodically and improve the electron and proton conductivity of Ni(OH)₂, allowing the anode to reach greater SOCs. Here, cobalt was embedded into the electrospun fibers, and evenly dispersed along the fibers, as shown in FIG. 13. The addition of cobalt resulted in a cathodic shift of the Ni(OH)₂/NiOOH reversible redox potential by 53 mV (FIG. 15). However, it also catalyzed the OER compared to the undoped anode, as shown by the steady-state Tafel plot in FIG. 15. The OER onset potential at the cobalt doped NFA was around 1.46 V_{RHE}, lower than for the undoped anode. Error! Reference source not found. summarizes the potential values derived from the CV scans and steady-state polarization tests of the doped and undoped anodes, including: Ni(OH)₂/NiOOH redox, oxidation and reduction potentials (E⁰, Eₒₓ and E_{red}, respectively), the OER onset potential (Eₒₙₛₑₜ) and the potential difference between Eₒₓ and Eₒₙₛₑₜ.

TABLE 3
Summary of key electrochemical parameters.
Electrochemical parameters extracted from the cyclic voltammograms and
steady-state polarization tests of Ni/Ni(OH)₂ and Ni/Ni_{0.9}Co_{0.1}(OH)₂ NF.

| | Eₒₓ | E_{red} | E⁰ | Eₒₙₛₑₜ | Eₒₙₛₑₜ − |
|---|---|---|---|---|---|
| | [V_{RHE}] | [V_{RHE}] | [V_{RHE}] | [V_{RHE}] | Eₒₓ [mV] |
| Ni/Ni(OH)₂ | 1.45 | 1.24 | 1.345 | 1.5 | 50 |
| NFA | | | | | |
| Ni/Ni_{0.9}Co_{0.1}(OH)₂ | 1.39 | 1.2 | 1.295 | 1.46 | 70 |
| NFA | | | | | |

Performance of Cobalt-Doped and Undoped NF Anodes in E-TAC Water Splitting

There are several key performance metrics in the selection and optimization of Ni(OH)₂ anodes for E-TAC water splitting. As discussed in the previous section, the first critical metric is the Ni(OH)₂ redox potential, which directly influences the cell voltage (see eq. 1) and therefore the process' voltage efficiency. Here, the anodes' charging potential was controlled by applying a constant polarization potential of either 1.48 or 1.43 V_{RHE} during the hydrogen generation step. The highest value, 1.48 V_{RHE}, was chosen since it is the thermoneutral water splitting voltage, i.e., this is the anode potential required in order to achieve a voltage efficiency of 100%_{HHV} during the hydrogen generation step, neglecting all other losses (see eq. 1).

The second key metric is the anode's charge capacity, as anodes with higher charge capacities can sustain longer cycles, reducing the cycling frequency. In this respect, Ni(OH)₂ anodes for E-TAC water splitting are similar to battery electrodes, which also benefit from high charge capacities that extend their operation duration between recharges. Thus, similarly to battery electrodes, the Ni(OH)₂ anodes are expected to exhibit high energy densities normalized by the anode's volume and mass. To achieve this, a sufficiently high mass loading is necessary, along with a high utilization efficiency of the active mass. It should be noted that, unlike battery electrodes, the Ni(OH)₂ anodes in E-TAC water splitting are regenerated in a chemical process, rather than an electrochemical one (discharge), and therefore the rate of their regeneration cannot be directly controlled. As a result, the charge that can be chemically regenerated, Q_{regen}, is often lower than the charge that can be extracted by electrochemical discharge; in electrochemical discharging, a preset electrochemical driving force or reaction rate is imposed by an external power source, whereas in chemical discharging the driving force and reaction rate decrease progressively as the NiOOH anode is discharged. In addition, the chemical discharging (regeneration) reaction takes place at the electrode-electrolyte interface and is limited by the diffusion of OH⁻ ions into the active material. Thus, while a high mass loading may improve the electrochemical charge capacity, it may not contribute to, and perhaps even reduce, the chemically-regenerated capacity, especially if it is achieved by increasing the bulk volume at the expense of surface area.

The third key metric is the current density during the hydrogen generation step, which is proportional to the hydrogen production rate. In this respect, Ni(OH)₂ anodes should support operation under high current densities normalized by the geometric area, similarly to alkaline electrolyzers, which typically operate at 200-400 mA/cm². However, in contrast to electrolyzer anodes wherein the OER takes place at the surface of the otherwise inert electrocatalyst, the charging reaction in the E-TAC water splitting process involves an electrochemical transformation of the anode itself from Ni(OH)₂ to NiOOH. Since the Ni(OH)₂ mass loading must be high enough to sustain high charge capacities, as discussed above, there is a trade-off between rate capabilities and charge capacity, similar to the trade-off observed in electrodes for supercapacitors.

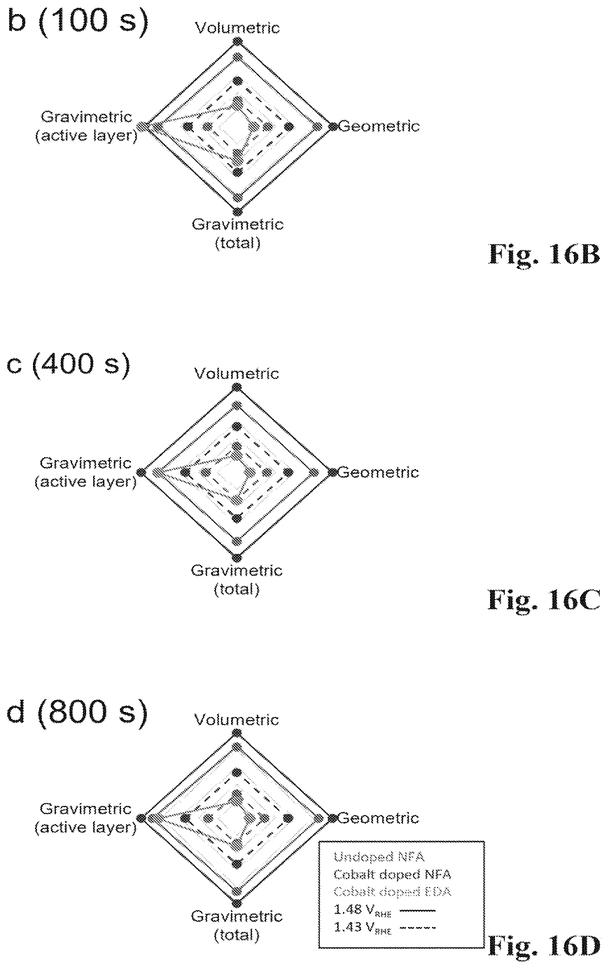

In each test, the average regenerated charge was calculated based on the current×time product, according to: Q_{regen}=∫i(t)·dt=<i>·t, (eq. 2); where t is the time, i(t) is the current as a function of time, and <i> is the average current over the entire test duration. Accordingly, for the tests carried out at 100, 200, 400 and 800s, the ratio between the average current (in A) and the regenerated charge (in A·s) is 100, 200, 400 and 800, respectively. FIG. 16 shows the regenerated charge capacities and current densities of the undoped and cobalt-doped NFAs compared to a cobalt-doped EDA. The values are normalized by all the key metrics, namely, the anode's volume, geometric area, total weight and active layer weight. The results are shown for tests carried out with equal durations of charging and regeneration of 100s (FIG. 16A), 200s (FIG. 16B), 400s (FIG. 16C) and 800s (FIG. 16D). The maximum values in each category are summarized in Table 2. Cobalt doping of the NFA resulted in enhanced performance in all metrics, with a higher charge and current density even at the low charging potential of 1.43 V_{RHE} compared to both the undoped NFA and the cobalt-doped EDA.

At a charging potential of 1.48 V_{RHE} (full line data series in FIG. 16), the regenerated charge capacity was higher for both the doped and undoped NFAs compared to the EDA in all categories, with the exception of a higher gravimetric charge capacity per unit mass of the active layer for the shortest test duration. However, as the test duration increased, the gravimetric charge capacity of the EDA fell short of the NFAs, suggesting a mass and/or charge transport limitation into the depth of the electrodeposited Ni(OH)₂ active layer. An opposite trend was observed for the NFAs, wherein the regenerated charge increased at longer test durations. This could be attributed to the high porosity of the Ni(OH)₂ layer, which enables facile mass transport and therefore enhances the rate of the diffusion-limited regeneration reaction.

Both the cobalt-doped and undoped NFAs displayed similar regenerated charge capacities at a charging potential of 1.48 V_{RHE} It therefore appears that under these experimental conditions, the benefits of cobalt doping were lost. Furthermore, the extent of the OER is greater at this potential for the cobalt-doped NFA compared to the undoped NFA. Indeed, 1.48 V_{RHE} lies anodicaly of the oxidation waves of both samples, and above the OER onset potential of the cobalt-doped NFA (FIG. 15). However, we hypothesize that the lower oxidation potential of the cobalt-doped NFA compared to the undoped NFA could enable extraction of a higher charge at lower potentials, increasing the voltage efficiency without compromising the Faradaic efficiency of the charging reaction. This was demonstrated by repeating the same tests for both samples at a charging potential of 1.43 V_{RHE}.

As expected, the charge that could be extracted from both NFAs at 1.43 V_{RHE} was lower than at 1.48 V_{RHE}. Nevertheless, while the undoped NFA's retained only 34-49% (depending on the test duration) of its charge compared to that at 1.48 V_{RHE}, the cobalt-doped NFA retained 54-57% of its charge under the same conditions. Moreover, the regenerated charge for the cobalt-doped NFA, even at the low charging potential of 1.43 V_{RHE}, surpassed that of the EDA when charged at 1.48 V_{RHE} (FIG. 16A-D, green lines). This is a significant improvement in anode performance, as the cobalt-doped NFA enables more charge to pass during the hydrogen production step, i.e., increased hydrogen production, at lower potentials that give rise to a higher voltage efficiency. In addition, as opposed to 1.48 V_{RHE}, charging at 1.43 V_{RHE} improves the charge acceptance and lowers the risk of parasitic oxygen evolution during anode charging, as the OER reaction rate at this anode is negligible at 1.43 V_{RHE} (FIG. 6). This was also demonstrated by dissolved oxygen measurements, as discussed below.

The high surface area of the hierarchical meso/macro porous structure of the NFAs resulted in a significant increase in the obtainable current density at each potential. Compared to the EDA, the average current densities of the undoped and cobalt-doped NFAs at 1.48 V_{RHE} were higher by up to 6.5 and 7.6 times, respectively. Furthermore, even at 1.43 V_{RHE}, the current densities of the NFAs were higher compared to the EDA when charged at 1.48 V_{RHE} (by up to 2.2 and 4 times for the undoped and doped NFAs, respectively). At both 1.48 and 1.43 V_{RHE} charging potentials, the cobalt-doped NFA achieved higher current densities compared to its undoped counterpart, which is attributed to the larger driving force, i.e., a larger difference between the applied potential (1.48 V_{RHE}) and the anode's redox potential.

The voltage efficiency of the E-TAC water splitting process using our cobalt-doped NFA in a two-electrode configuration was also compared to our previously reported anode. At a current density of 50 mA/cm² (normalized by the geometric area), the low charging potential of the cobalt-doped NFA resulted in an overall lower cell voltage, with an increase in average voltage efficiency from 98.7% to 100%.

The fourth key metric in E-TAC water splitting is the Faradaic efficiency of the Ni(OH)₂ charging reaction, (1−Q_{OER}/Qₜₒₜₐₗ, where Q_{OER} is the parasitic charge of the OER during the hydrogen generation step, and Qₜₒₜₐₗ is the total charge passed during the hydrogen generation step). The Faradaic efficiency is influenced by the cycle duration, which is linked to the anode's SOC, as well as by the anode's charging potential and its relation to the OER onset potential at the same anode. Q_{OER} was calculated at each E-TAC water splitting test from the measured amount of dissolved oxygen. At 1.48 V_{RHE} charging potential, the Faradaic efficiency of the cobalt-doped NFA was high for the short tests (99%±1% for the 100s test and 98.5%±0.7% for the 200s test), but it decreased with increasing test duration, i.e., upon charging to higher SOCs, reaching 94%±3% for the 400s test, and only 85%±2% for the 800s test. However, by lowering the charging potential to 1.43 V_{RHE}, the Faradaic efficiency for the cobalt-doped NFA increased, reaching 98%±2% at the longest (800s) test. This result was expected, as the oxygen evolution rate is negligible at this potential. In fact, the ratio between the steady-state OER rate (FIG. 15) and the overall reaction rate during charging can be used to estimate the lower limit of the Faradaic efficiency. Thus, the combination of increased surface area, porosity and cobalt doping significantly improves the anode's performance and allows operation at lower potentials with higher charge capacities and better rate capabilities. For example, a cobalt-doped NFA can withstand long cycles of 800s charging and regeneration, at a potential lower by 50 mV (1.43 V_{RHE}) while supplying charge and current densities that are up to 4 times greater (depending on the normalization basis) compared to the cobalt-doped EDA, at a Faradaic efficiency of ˜100%.

In addition to the current density during the hydrogen generation step of the E-TAC water splitting cycle, it is advantageous for the oxygen generation step to be faster than the hydrogen generation step. This way the overall hydrogen production throughput is maximized. The fifth key metric is therefore the regeneration reaction rate, or the charge that can be regenerated at a given regeneration time, which is correlated to the hydrogen production throughput. To examine the influence of the anode preparation method on the regeneration rate, the E-TAC water splitting tests were repeated with shorter regeneration steps of only 100s. For the EDA, decreasing the regeneration time resulted in a capacity drop of up to 31±14%. However, for the undoped and cobalt-doped NFAs, the capacity dropped by only 12±4% and 13±4%, respectively. The enhanced surface area and availability of active sites of the NFAs thus also facilitate higher chemical reaction rates, increasing the hydrogen production throughput without a substantial loss in capacity. For example, a two-fold increase in hydrogen production duration (from 100s to 200s) with the cobalt-doped NFA corresponds to an overall hydrogen production throughput increase of 33%, with a capacity loss of less than 4%.

Finally, a highly important performance metric is the anode's cycling stability. Ni(OH)₂ battery electrodes can withstand thousands of electrochemical charge-discharge cycles by avoiding overcharging, as discussed above. Moreover, we have previously shown that the electrochemical discharge (reduction) of NiOOH can be seamlessly replaced by chemical regeneration without damage or degradation of the anode's microstructure, phase composition or chemical composition. Here, the cycling stability of an undoped NFA was demonstrated by subjecting it to a series of 100 E-TAC water splitting cycles. After about 20 cycles, both anodes displayed high stability up the 100th cycle (Q=5.2±0.3C and Q=1.8±0.2 C for the EDA and NFA, respectively), with similar X-ray diffraction pattern and morphology to those observed after layer growth by galvanic cycling. This is a preliminary positive indication of the anode's cycling stability in E-TAC water splitting.

Anode Optimization: Effect of Fiber Morphology

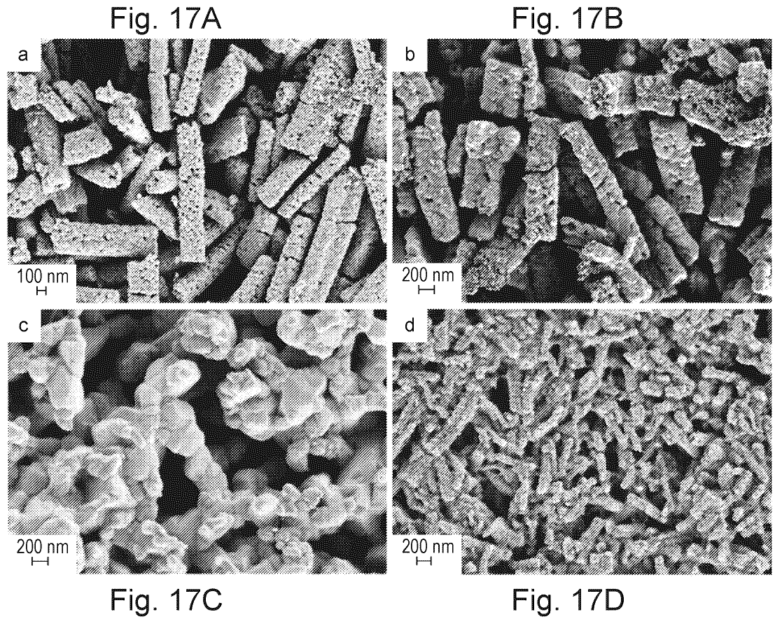

The electrochemical properties of a core-shell Ni/Ni(OH)₂ NFA depend on the microstructure and surface area of the nickel substrate. Tuning the anode's microstructure and consequent electrochemical performance is possible by controlling the various synthesis process parameters. To demonstrate this, we explored the influence of the fiber microporosity and diameter on the charge density of the resulting anodes. SEM images of three nickel nanofiber substrates prepared with maximum sintering temperatures of 500, 600, and 700° C. are shown in FIGS. 17A, B and C, respectively. The sintering temperature affects the fiber micro-structure and porosity, with almost complete loss of microporosity after sintering at 700° C., leaving only a very coarse granular microstructure. Preliminary electrochemical performance was then evaluated by electrochemical charge-discharge cycles, showing a three-fold increase in volumetric charge capacity for the anode sintered at 500° C. compared to 700° C., presenting a clear advantage for maintaining a fine porous structure by controlling the sintering temperature.

Next, we looked at the fiber diameter, and its effect on the anode's performance. We postulated that reducing the fiber diameter would contribute to an enhanced performance both by increasing the active surface area, and by increasing the weight ratio of the active shell layer and the nickel core. Thinning the fiber diameter was achieved by diluting the original precursor solution, so that its viscosity decreased twofold, and by raising the voltage during the ES process, which resulted in extra stretching of the fibers during electrospinning. FIG. 17D shows the SEM images of a nickel nanofiber substrate having a fiber diameter of 130 nm. The preliminary electrochemical performance demonstrates that reducing the fiber diameter by half results in almost doubling of the volumetric charge capacity.

1-43. (canceled)

44. An electrically conductive capsule comprising an electrically conducting network core comprising a plurality of fibers exhibiting open hierarchical porosity, the capsule having a porosity enabling flow of liquid and gases therethrough.

45. The capsule according to claim 44, the capsule being an electrically conductive porous capsule encapsulating an electrically conductive porous network of conducting fibers, each having an open hierarchical porosity, wherein the conductive porous capsule conducts electricity to the fibers contained therein and permits liquid and gaseous communication therethrough.

46. An electrically conductive porous capsule encapsulating an electrically conductive porous network of conducting fibers, each having an open hierarchical porosity, wherein the conductive porous capsule conducts electricity to the fibers contained therein and permits liquid and gaseous communication therethrough.

47. The capsule according to claim 44, wherein the conducting fibers are composed of a high surface-area conductive material having open hierarchical porosity.

48. The capsule according to claim 44, wherein the conductive fibers are composed of a conductive material being a metallic material, a carbonaceous material or a polymeric material.

49. The capsule according to claim 48, wherein the conductive fibers comprise a metallic material, optionally selected from nickel, zinc, aluminum and magnesium.

50. The capsule according to claim 49, wherein the metallic material is or comprises nickel.

51. The capsule according to claim 49, wherein the metallic material is or comprises Ni(OH)₂ or Ni/Ni(OH)₂.

52. The capsule according to claim 51, wherein the conductive fibers are core-shell structures comprising each a Ni core and a Ni(OH)₂ shell.

53. The capsule according to claim 49, wherein the conductive fibers comprise nickel, optionally in combination with at least one other metal.

54. The capsule according to claim 44, wherein the conductive fibers are manufactured by a process comprising treating a composite of a conductive material and a polymeric binder under conditions sufficient to remove the polymeric binder to obtain the conductive fibers.

55. The capsule according to claim 54, wherein the conductive material is in a form of electrospun conductive fibers.

56. The capsule according to claim 54, wherein the process comprises treating a composite of a conductive material and at least one polymeric binder under conditions sufficient to remove the polymeric binder and obtain conductive fibers having open hierarchical porosity.

57. The capsule according to claim 54, wherein the process comprises treating conductive fibers with at least one polymeric binder to form a composite of the conductive fibers and the at least one polymer.

58. The capsule according to claim 54, wherein the conductive material is a metal.

59. The capsule according to claim 54, wherein the conductive material is a metallic conductive material provided in a form of a mat or foam of fibers, and wherein process comprises:
forming a metal fiber mat or foam;
grinding the foam to obtain fragments of said mat or foam;
treating said fragments with a polymeric binder to obtain a metal-polymer composite;
treating the composite under conditions sufficient to remove the polymeric binder and obtain a plurality of conductive fibers having each open hierarchical porosity.

60. The capsule according to claim 54, wherein the conductive fibers are prepared by a process comprising:
electrospinning a solution comprising at least one nickel precursor and optionally at least one another metal precursor to provide a fiber mat or foam comprising the at least one nickel precursor and optionally the at least one another metal precursor;
transforming the nickel precursor in said mat or foam to nickel oxide (NiO) to provide a NiO mat or foam;
grinding the NiO mat or foam into a powder to obtain fragments of the NiO fibers and mixing with a polymer binder to form a composite;
transforming the NiO in said composite into nickel metal (NiO) under conditions permitting removal of the polymeric binder to provide porous nickel conductive fibers; and
transforming at least some of the nickel metal (NiO) in the fibers to Ni(OH)₂ to thereby afford the Ni/Ni(OH)₂ fibers.

61. A microelectrode in a form of a capsule according to claim 44.

62. A system for generation of hydrogen and/or oxygen gas, the system comprising a plurality of microelectrodes according to claim 61 dispersed in a medium.

63. The system according to claim 62, comprising an electrochemical device configured for generating the gases.

64. The system according to claim 63, wherein the electrochemical device is an electrochemical thermally activated chemical cell (E-TAC).

65. An electrochemical device for generation of a gas by utilizing microelectrodes according to claim 61, the device being adapted and operable to convert the microelectrodes from an oxidized form to a reduced form.

66. A medium of an electrochemical cell comprising a plurality of capsules according to claim 44.

67. An anode electrode in a form of a microelectrode according to claim 61.

68. A device comprising a microelectrode according to claim 61, the device being selected from electric cells, electric furnaces, thermionic tubes, gas-discharge devices, semiconductor devices and electrochemical cells.
